(19) United States
(12) Patent Application Publication
(10) Pub. No.: US 2004/0211299 A1
(43) Pub. Date: Oct. 28, 2004

(54) Joint for connecting wrench with socket

(76) Inventor: Terence Chen, Yi Lan Hsien (TW)

Correspondence Address: Alan D. Kamrath, NIKOLAI & MERSEREAU, P.A.,, 820 INTERNATIONAL CENTRE, 900 SECOND AVENUE SOUTH, Minneapolis, MN, 55402, US

(21) Appl. No.: 10/437,791

(22) Filed: May 14, 2003

(30) Foreign Application Priority Data
Apr. 22, 2003 (TW) 92109544

(51) Int. Cl. B25B 13/06

(52) U.S. Cl. 81/121.1

(57) ABSTRACT

A toolkit includes at least one socket made according to the metric system, a first joint for connecting a head of a wrench with the at least one socket made according to the metric system, a first ring made of a first color and mounted on the first joint, at least one socket made according to the British system, a second joint for connecting the head of the wrench with the at least one socket made according to the British system and a second ring made of a second color other than the first color and mounted on the second joint.

### FIELD OF INVENTION

The present invention relates to a joint for connecting a wrench with a socket.

### BACKGROUND OF INVENTION

Taiwanese Patent Publication No. 155930 discloses a wrench 10 with a handle 11, an annular head 12 integrated with the handle 11, a joint 20 put in the annular head 12 for connection with a socket and a direction controller 30 engaged with the joint 20 for controlling the direction of rotation of the joint 20 relative to the annular head 12. The joint 20 includes a disc 21, a cylinder 22 extending form the disc 21 and a square insert 23 extending from the cylinder 22. The square insert 23 is inserted through the annular head 12. The cylinder 22 is put in the annular head 12. The disc 21 is put against the annular head 12. The square insert 23 can be inserted in a square hole defined in the socket. The cylinder 22 is formed with teeth. The direction controller 30 is formed with teeth engaged with the teeth of the cylinder 22. Many fasteners are made according to the metric system while the others are made according to the British system. Accordingly, a toolkit often includes sockets and joints made according to the metric system and sockets and joints made according to the British system. It is however not unusual for a user to try several times before he picks up a joint made according to the right system for a socket.

The present invention is therefore intended to obviate or at least alleviate the problems encountered in prior art.

### SUMMARY OF INVENTION

According to the present invention, a toolkit includes at least one socket made according to the metric system, a first joint for connecting a head of a wrench with the at least one socket made according to the metric system, a first ring made of a first color and mounted on the first joint, at least one socket made according to the British system, a second joint for connecting the head of the wrench with the at least one socket made according to the British system and a second ring made of a second color other than the first color and mounted on the second joint.

Other objects, advantages, and novel features of the invention will become more apparent from the following detailed description when taken in conjunction with the attached drawings.

### BRIEF DESCRIPTION OF DRAWINGS

The present invention will be described via detailed illustration of embodiments referring to the drawings.

FIG. 1 is a perspective view of a socket wrench equipped with a joint according to a first embodiment of the present invention.

FIG. 2 is an exploded view of the socket wrench shown in FIG. 1.

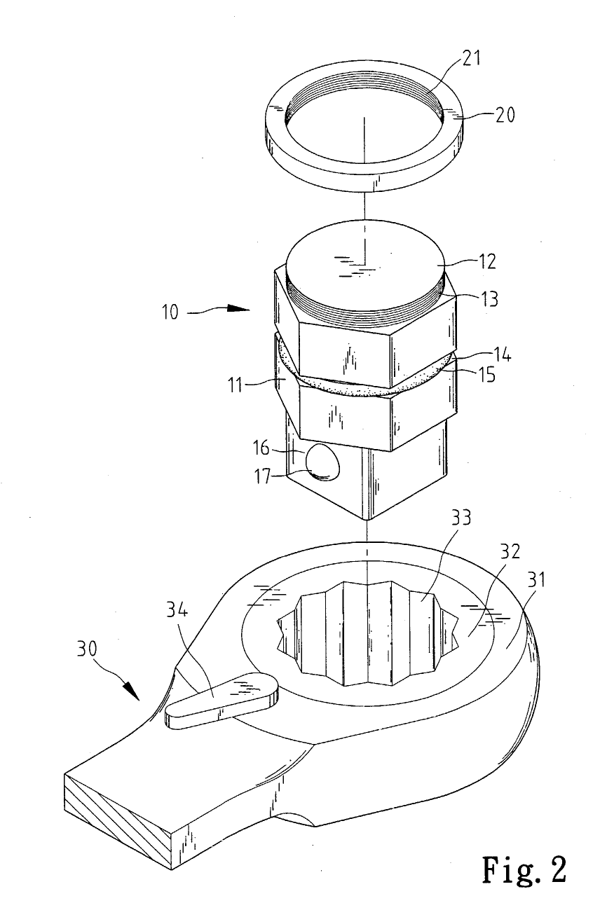

FIG. 3 is a partially cross-sectional view of the socket wrench shown in FIG. 1.

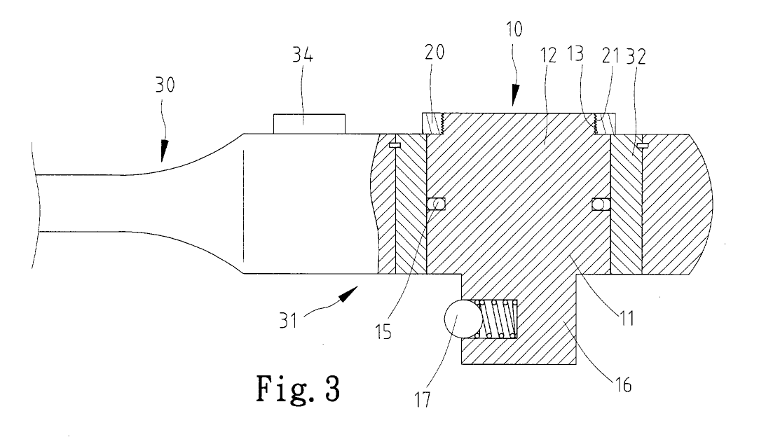

FIG. 4 is an exploded view of a socket wrench equipped with a joint according to a second embodiment of the present invention.

FIG. 5 is a partially cross-sectional view of the socket wrench shown in FIG. 4.

FIG. 6 is a perspective view of a box containing sockets and joints according to the present invention.

### DETAILED DESCRIPTION OF EMBODIMENTS

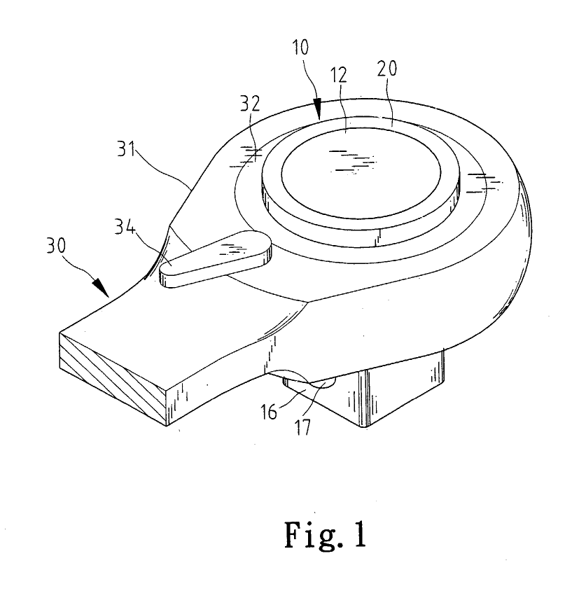

Referring to FIGS. 1˜3, a socket wrench 30 is equipped with a joint 10 according to a first embodiment of the present invention.

The socket wrench 30 includes a handle (not numbered and shown partially), an annular head 31 integrated with the handle, a ring 32 put in the annular head 31 and formed with a star-shaped internal face 33 for engagement with the joint 10, a direction controller (not shown) arranged between the annular head 31 and the ring 32 and a switch 34 mounted on the annular head 31 and connected with the direction controller. The socket wrench 30 will not be described in detail for being conventional.

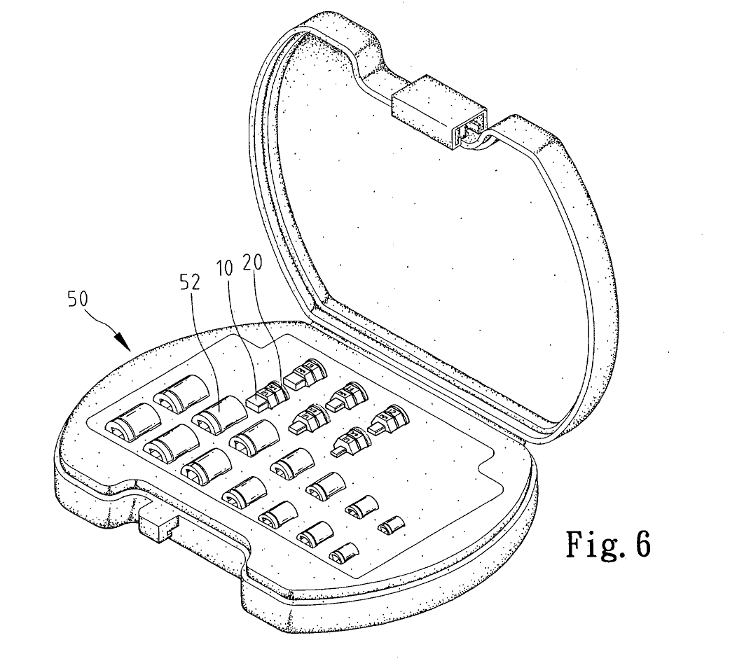

The joint 10 includes a hexangular portion 11, a circular portion 12 formed at an upper end of the hexangular portion 11 and a square portion 16, formed at a lower end of the hexangular portion 11. The hexangular portion 11 is for engagement with the ring 32. An annular groove 14 is defined in the hexangular portion 11. A ring 15 is put in the annular groove 14 for retaining the hexangular portion 11 in the ring 32. A thread 13 is formed on the circular portion 12. The square portion 16 is for insertion in a square hole defined in a socket (see FIG. 6). A detent 17 is installed at the square portion 16 for retaining the square portion 16 in the socket.

A ring 20 includes, on an internal face, a thread 21 for engagement with the thread 13, thus securing the ring 20 to the joint 10. The ring 20 is put against the ring 32, thus avoiding the joint 10 escaping the ring 32.

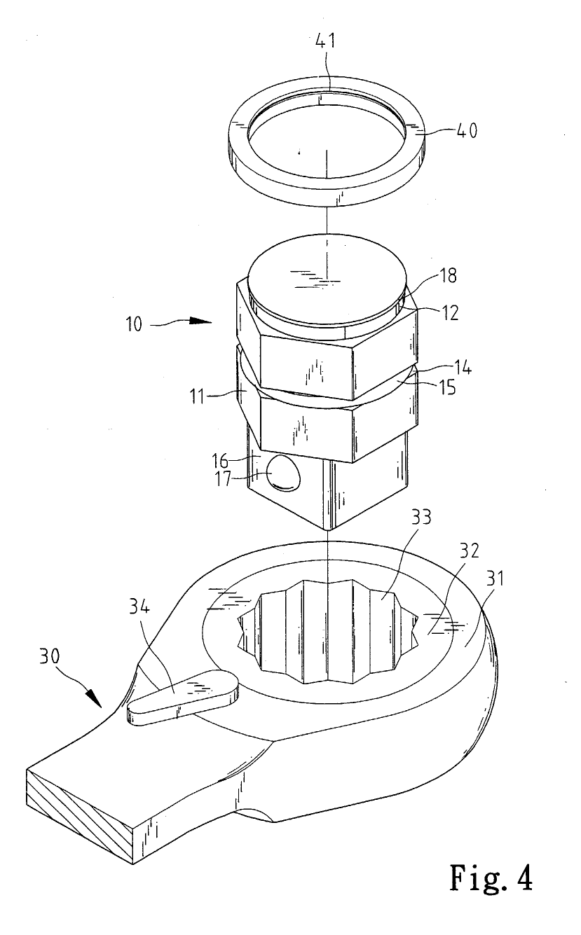

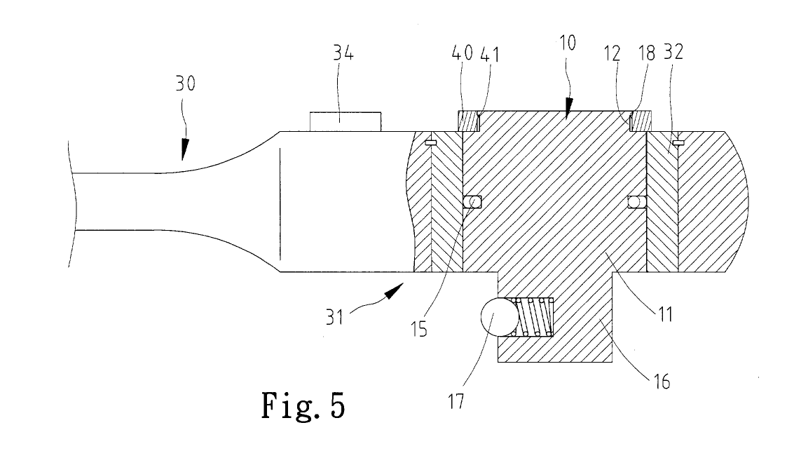

FIGS. 4 and 5 show the socket wrench 30 equipped with a joint 10 according to a second embodiment of the present invention. The second embodiment is different from the first embodiment only in two aspects. Firstly, of the thread 13 is replaced with an annular flange 18. Secondly, the ring 20 including the thread 21 is replaced with a ring 40 including an annular flange 41. The ring 40 is mounted on the circular portion 12. The annular flange 41 is moved beyond the annular flange 18 by force, thus securing the ring 40 to the joint 10.

Referring to FIG. 6, a box 50 contains a toolkit. The toolkit includes a first group of sockets 52 and joints 10 and a second group of sockets 52 and joints 10. For example, the first group is made according to the metric system, and the second group according to the British system. The rings 20 of the joints 10 of the first group are made of a different color or shape than that of the rings 20 of the joints 10 of the second group. Therefore, it is easy for a user to pick up a joint 10 made according to the right system for a socket 52.

The present invention has been described via detailed illustration of embodiments. Those skilled in the art can derive variations from the embodiments without departing from the scope of the present invention. Therefore, the embodiments shall not limit the scope of the present invention defined in the claims.

What is claimed is:

1. A toolkit including at least one socket made according to the metric system, a first joint for connecting a head of a wrench with the at least one socket made according to the metric system, a first ring made of a first color and mounted on the first joint, at least one socket made according to the British system, a second joint for connecting the head of the wrench with the at least one socket made according to the British system and a second ring made of a second color other than the first color and mounted on the second joint.

2. The toolkit according to claim 1 wherein the joint includes a first portion for releasable engagement with the head of the wrench and a second portion for releasable engagement with the at least one socket.

3. The toolkit according to claim 2 wherein the first portion is a hexangular portion.

4. The toolkit according to claim 2 wherein the second portion is a square portion.

5. The toolkit according to claim 2 wherein the joint includes a circular portion formed on the first portion, and the ring is mounted on the circular portion.

6. The toolkit according to claim 5 wherein the joint includes a thread formed on the circular portion, and the ring includes a thread formed on an internal face for engagement with the thread of the joint.

7. The toolkit according to claim 5 wherein the joint includes an annular flange formed on the circular portion, and the ring includes an annular flange formed on an internal face for engagement with the annular flange of the joint.

8. The toolkit according to claim 2 wherein the joint includes a ring mounted on the first portion for frictional contact with the head of the wrench.

9. The toolkit according to claim 8 wherein the first portion defines an annular groove for receiving the ring.

10. The toolkit according to claim 2 wherein the joint includes a detent installed at the second portion for frictional contact with the socket made according to one of the metric system and the British system.

11. A toolkit including at least one socket made according to the metric system, a first joint for connecting a head of a wrench with the at least one socket made according to the metric system, a first ring made of a first shape and mounted on the first joint, at least one socket made according to the British system, a second joint for connecting the head of the wrench with the at least one socket made according to the British system and a second ring made of a second shape other than the first shape and mounted on the second joint.

12. The toolkit according to claim 11 wherein the joint includes a first portion for releasable engagement with the head of the wrench and a second portion for releasable engagement with the at least one socket.

13. The toolkit according to claim 12 wherein the first portion is a hexangular portion.

14. The toolkit according to claim 12 wherein the second portion is a square portion.

15. The toolkit according to claim 12 wherein the joint includes a circular portion formed on the first portion, and the ring is mounted on the circular portion.

16. The toolkit according to claim 15 wherein the joint includes a thread formed on the circular portion, and the ring includes a thread formed on an internal face for engagement with the thread of the joint.

17. The toolkit according to claim 15 wherein the joint includes an annular flange formed on the circular portion, and the ring includes an annular flange formed on an internal face for engagement with the annular flange of the joint.

18. The toolkit according to claim 12 wherein the joint includes a ring mounted on the first portion for frictional contact with the head of the wrench.

19. The toolkit according to claim 18 wherein the first portion defines an annular groove for receiving the ring.

20. The toolkit according to claim 12 wherein the joint includes a detent installed at the second portion for frictional contact with the socket made according to one of the metric system and the British system.
